(19) United States
(12) Patent Application Publication
(10) Pub. No.: US 2026/0183949 A1
(43) Pub. Date: Jul. 2, 2026

(54) SPLINE MOTION CONTROL

(71) Applicant: FANUC America Corporation, Rochester Hills, MI (US)

(72) Inventors: Sai Kai Cheng, Rochester Hills, MI (US); Peter Swanson, Bloomfield Hills, MI (US); Nivedhitha Giri, Farmington Hills, MI (US); Yi Luo, Rochester Hills, MI (US); Min-Ren Jean, Rochester Hills, MI (US)

(21) Appl. No.: 19/006,402

(22) Filed: Dec. 31, 2024

(51) Int. Cl. B25J 9/16; B25J 15/00

(52) U.S. Cl. CPC B25J 9/1664; B25J 9/1671; B25J 15/0019

(57) ABSTRACT

A method for programming a robotic continuous path using spline motion control. A set of path points are provided to a robot controller, either from CAD data or a teach device. A motion program is defined referencing the path points. Where three or more spline motion commands appear in sequence, a spline curve is computed. The spline curve comprises a set of adjacent parabolas or circular arcs, each of which passes through three path points, and overlapping sections of adjacent parabolas/arcs are blended. The spline curve passes through all of the path points, and there are no restrictions on path point spacing; large inter-point spacing can be followed by small spacing, and vice versa. Automatic speed controls are applied to the spline curve based on tool center point motion and joint motion. User-configurable tool orientations may be applied to the spline curve, and time-based and distance-based trigger points are definable.

### BACKGROUND

### Field

The present disclosure relates to the field of industrial robots and, more particularly, to a method for programming a robot tool center point to follow a spline curve defined by a set of taught points, where the spline curve comprises a set of adjacent quadratic or circular arc functions which are blended in overlapping regions, the spline curve passes through each of the taught points, and the taught points may have any arbitrary spacing.

### Discussion of the Related Art

The use of robots to consistently perform industrial operations which involve accurately following a path is known in the art. One example of a path-following application is where a robot is used to weld together two components along a complex three-dimensional path—such as two sheet metal cylinders of different diameters which intersect at an oblique angle. In this type of application, many points are typically defined along the desired path, either from a CAD system or by “teaching” the robot on an actual workpiece, and the taught points are provided to a robot controller. However, until now, programming the robot to precisely follow the prescribed path has been a trial and error process which is often difficult and time-consuming. This is because some existing robot “spline motion” programming techniques place limitations on the spacing of the taught points which often precludes the programming operator from placing the taught points at desired locations and intervals.

In addition to the welding application discussed above, robots are also used for many other path following operations—such as material dispensing, cutting, tracing, spray painting, etc. In any of these applications where a tool center point needs to follow a prescribed path while performing an operation, the ability to accurately and conveniently define the path is important. Existing spline motion programming techniques have proven inadequate in terms of their ability to define taught points at arbitrary locations and spacing, and apply tool center point speed control and flexible triggering of process equipment while the tool is moving along the spline curve.

In light of the circumstances described above, it is desired to provide an improved spline motion computation technique which can be used for programming a robot to perform an operation along a continuous path.

### SUMMARY

In accordance with the teachings of the present disclosure, a method for programming a robotic continuous path using spline motion control is described. A set of path points are provided to a robot controller, either from CAD data or by using a teach pendant or equivalent device with a physical workpiece in the robot work cell. A motion program is defined using robot motion commands which reference the path points. Where three or more spline motion commands appear in sequence, a spline curve is computed. The spline curve is comprised of a set of adjacent parabolas or circular arcs, each passing through three path points, and overlapping sections of adjacent parabolas or circular arcs are blended using a configurable blending algorithm. The spline curve passes through all of the path points, and there are no restrictions on the placement or spacing of path points; a large inter-point spacing can be followed by a small spacing, and vice versa. Automatic speed controls are applied to the spline curve based on tool center point motion and joint motion. User-configurable tool orientations may be applied to the spline curve, and both time-based and distance-based trigger points are available relative to the spline curve.

Additional features of the presently disclosed techniques will become apparent from the following description and appended claims, taken in conjunction with the accompanying drawings.

### BRIEF DESCRIPTION OF THE DRAWINGS

FIG. 1 is an illustration of a set of points describing a path to be used for spline motion control by an industrial robot, as known in the art;

FIG. 2 is an illustration of problems experienced by some existing robot motion control systems when attempting to fit a spline curve to the set of points of FIG. 1;

FIG. 3 is an illustration of the desired spline curve fit behavior applied to the set of points of FIG. 1, according to an embodiment of the present disclosure;

FIG. 4 is an illustration of a spline curve fit to a set of three adjacent path points, along with corresponding robot motion commands, according to an embodiment of the present disclosure;

FIG. 5 is an illustration of a spline curve fit to a set of four adjacent path points, demonstrating how curves are fit to groups of three adjacent points and combined into a spline curve passing through all of the path points, according to an embodiment of the present disclosure;

FIGS. 6A, 6B and 6C are graphs of quadratic functions of x, y and z, respectively, with respect to a spline parameter u, illustrating curve fitting calculations through a set of three path points according to an embodiment of the present disclosure;

FIGS. 7A, 7B and 7C are graphs of linear, cosine and quintic blending functions, respectively, which may be used for computing a blending curve in overlapping portions of adjacent parabolas or circular arcs in a spline curve, according to embodiments of the present disclosure;

FIG. 8 is an illustration of a robot tool during spline motion, with and without orientation control with respect to a fixed reference frame, according to an embodiment of the present disclosure;

FIG. 9 is an illustration of a system for providing industrial robot spline motion control, according to an embodiment of the present disclosure; and

FIG. 10 is a flowchart diagram of a method for spline motion control for a robot or other industrial machine, according to an embodiment of the present disclosure.

### DETAILED DESCRIPTION OF THE EMBODIMENTS

The following discussion of the embodiments of the disclosure directed to a method and system for programming a robotic path using spline motion control is merely exemplary in nature, and is in no way intended to limit the disclosed devices and techniques or their applications or uses.

Industrial robots are very good at performing repetitive tasks consistently. In particular, robots are capable of moving such that a tool center point (TCP) follows almost any path which can be defined in two or three dimensions. This has given rise to the use of robots for various path-following operations—such as welding (laser, torch or arc), cutting, spray painting and material dispensing. However, defining a path which follows a set of arbitrarily-located points has been problematic in some instances.

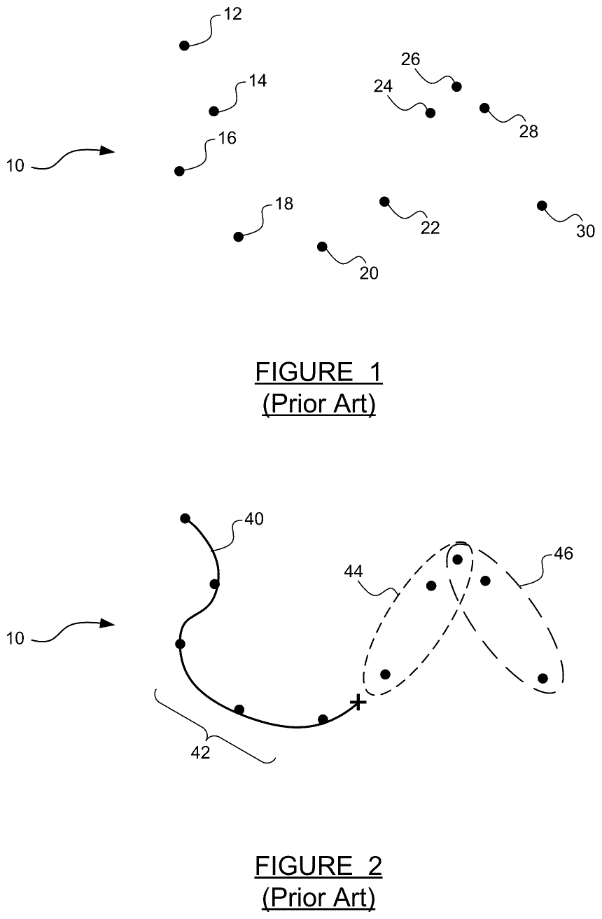

FIG. 1 is an illustration of a set 10 of path points describing a path to be used for spline motion control by an industrial robot, as known in the art. The set 10 of path points includes individual path points 12-30 (even numbers). The points 12-30 may describe, for example, an edge of a first workpiece which is to be welded to a second workpiece by the robot. The points 12-30 may be defined by computer-aided design (CAD) data, or may be taught using conventional robot point teaching techniques such as those involving a teach pendant device, a tablet device or an augmented reality (AR) device. The points 12-30 may describe any two-dimensional or three-dimensional path shape. Because of the near-infinite variety of part shapes and robotic applications, the points 12-30 often include characteristics such as arbitrary curvatures and widely-varying spacing between points, where these characteristics have been problematic for some existing robotic spline motion control systems.

FIG. 2 is an illustration of problems experienced by some existing robot motion control systems when attempting to fit a spline curve to the set of points of FIG. 1. FIG. 2 includes the same set 10 of path points 12-30 as in FIG. 1. A spline curve 40 is computed based upon the points 12-30 using a prior art technique. It can be seen at a location designated as 42 that the spline curve 40 is fit to about the first half of the set 10 of path points, but then a problem is encountered. Some existing robot motion control systems place limitations on the spacing between adjacent points which are allowed to be included in a spline curve. In particular, some existing systems require that, for each adjacent group of three points, the middle point of the three is located between 25% and 75% of the distance between the end points. In FIG. 2, it can be seen that the points 24, 26 and 28 are very tightly spaced in an area of high curvature, while the adjacent points 22 and 30 are much more distant. As a result, the point 24 does not fall within the 25-75% range between the points 22 and 26, and the spline curve 40 is therefore unable to use the points 22, 24 and 26 as shown in ellipse 44. Likewise, the point 28 does not fall within the 25-75% range between the points 26 and 30, and the spline curve 40 is therefore unable to use the points 26, 28 and 30 as shown in ellipse 46. Consequently, using some existing spline motion control systems, the spline curve 40 cannot be computed to pass through the point sequence 22-24-26-28-30 of the set 10.

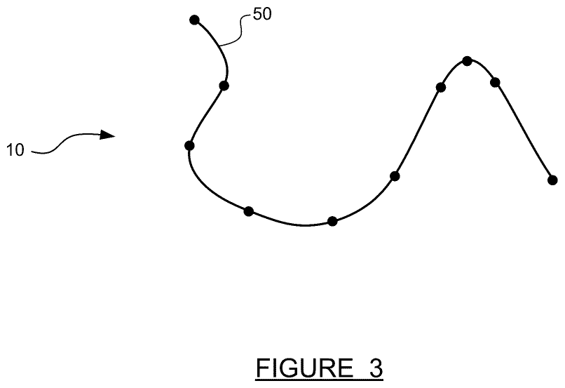

FIG. 3 is an illustration of the desired spline curve fit behavior applied to the set 10 of points of FIG. 1, according to an embodiment of the present disclosure. Using the spline curve computation techniques discussed in detail below, a spline curve 50 can be computed which faithfully passes through all of the points 12-30 in the set 10, including the point sequence 22-24-26-28-30 which includes widely varying spacing between points. The spline curve 50 provides the results expected by a programming operator, and avoids the trial-and-error approach of moving path points in an attempt to cause the spline curve to follow the desired path, while also eliminating the need for the operator to add superfluous path points in order to comply with point spacing limitations.

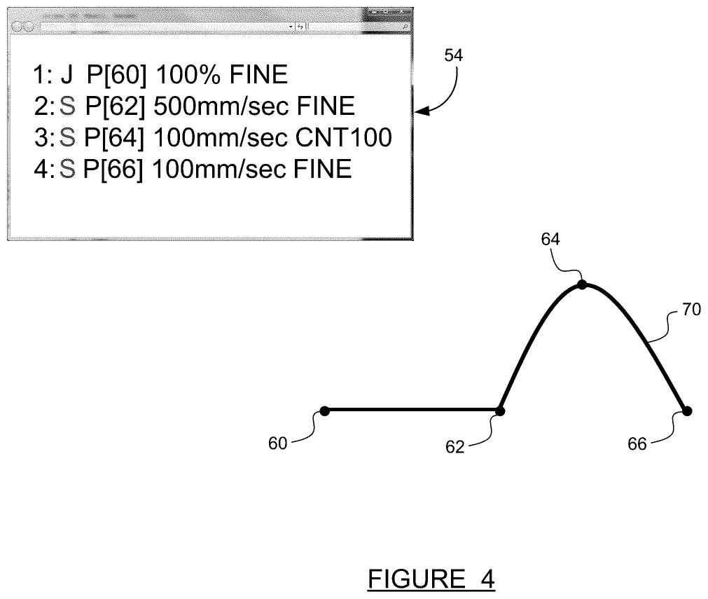

FIG. 4 is an illustration of a spline curve fit to a set of three adjacent path points, along with corresponding robot motion commands, according to an embodiment of the present disclosure. A sequence of robot motion programming commands is shown in a window 54, referring to the points shown at the right of FIG. 4. Path points 60, 62, 64 and 66 are defined—either from a CAD system or by using a teach pendant or equivalent device. The point 60 defines a starting point, and is used in a “joint” (J motion type) command which simply causes the robot to move the joints, such as in the fastest way possible, to place the tool center point at the point 60. Then a sequence of “spline” (S motion type) commands are used, referring to the points 62, 64 and 66, respectively.

When a first S motion command is encountered following any other type of motion command, the move from the previous point to the first S point (62) is linear. When three S motion commands are encountered in succession, the robot controller computes a quadratic function (graphically a parabola), or alternately a circular arc, to fit through the three points called out in the three S motion commands. In FIG. 4, a parabola 70 is fit to the path points 62, 64 and 66 in a manner which will be discussed below. The motion programming commands shown in the window 54 include other parameters besides the motion type and the point identifier, including a speed parameter (defined as an absolute velocity or a percentage) and a termination type (which designates speed continuity and other effects at the destination point).

FIG. 4 illustrates a spline curve consisting of the single parabola 70, which is the most basic scenario for spline curve computation and spline motion control according to the present disclosure. Much more interesting and useful are scenarios where a spline curve is fitted to a sequence of path points containing many points. How this is done is discussed further below.

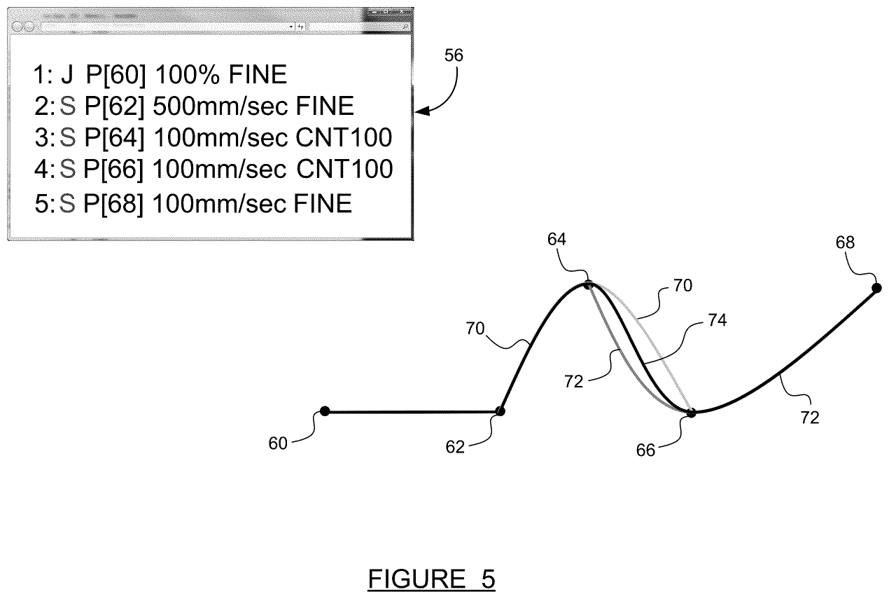

FIG. 5 is an illustration of a spline curve fit to a set of four adjacent path points, demonstrating how curves are fit to groups of three adjacent points and combined into a spline curve passing through all of the path points, according to an embodiment of the present disclosure. FIG. 5 includes the same path points 60-66 as shown in FIG. 4, and also includes a fifth path point 68. A sequence of robot motion programming commands is shown in a window 56, referring to the points 60-68. In this case, the path point 68 is also called with a spline (S) motion type, which results in four S motions in sequence.

The parabola 70 is still visible in FIG. 5, where the parabola 70 is fitted to the path points 62, 64 and 66 as discussed above. A parabola 72 is computed to fit the path points 64, 66 and 68. The parabolas 70 and 72 are each labelled twice in FIG. 5 to clearly identify them. A blend curve 74 is computed for the overlapping portions of the parabolas 70 and 72—that is, the section between the points 64 and 66. The complete spline curve for the points 62-68 then traces the parabola 70 from the point 62 to the point 64, the blend curve 74 from the point 64 to the point 66, and the parabola 72 from the point 66 to the point 68.

Using the technique of the present disclosure illustrated in FIG. 5, a spline curve can be fitted to a sequence of path points having as many points as necessary to define the desired path—including dozens of path points or more. For descriptive purposes, the path points may be identified as P1-PN. In summary, the technique includes computing a quadratic function (parabola) to fit the first three path points (P1-P2-P3) in the spline sequence, dropping the first point and including the fourth point to create a next set of three points and computing a parabola to fit this next set of three points (P2-P3-P4), and so on until the last point PN is reached. Another way to say this is that a quadratic function or parabola is computed to fit each unique set of three adjacent path points. A blend curve is then computed to span the overlapping portion of each adjacent pair of parabolas, and the overall spline curve follows the first segment of the first parabola (from P1 to P2), each of the blend curves in sequence, and the last segment of the last parabola (from PN−1 to PN).

In an alternate embodiment, a circular arc may be computed (instead of a quadratic function or parabola) to fit each unique set of three adjacent path points. This is discussed further below. Blending of the overlapping portions of adjacent circular arcs is performed in the same manner as described above.

The technique discussed above results in a spline curve which passes directly through every path point. Furthermore, the technique does not place any restrictions on the spacing between adjacent path points—the points can include fairly uniform spacing, widely varying spacing, or any combination thereof. The programming operator can therefore place path points wherever he or she feels they are necessary to define the desired path, without worrying about the points being disqualified by the spline motion computation program.

Another feature of the presently disclosed spline curve calculations, apparent from the preceding discussion, is that the spline curve path can be computed initially knowing only a subset of the points in the entire path. For example, consider a case where the first four path points P1-P4 are defined in a conventional way (CAD or teach), and where some later path points, including P5, are designated by position registers such that the point location may change based on an external input or other calculation. In this type of situation, the spline curve can be computed for the first four points as in FIG. 5 and the robot can begin following the spline path; then as long as the location of the fifth point P5 (a position register) is known before the robot tool center point reaches the third point P3, the parabola (or circular arc) for points P3-P4-P5 can be computed and the blend curve for the overlapping section P3-P4 can also be computed so that the robot can continue the program motion seamlessly past P3.

The spline curve calculations discussed above include two main parts; the computation of the quadratic function (parabola) or circular arc to fit each set of three adjacent path points, and the computation of the blend curves which span the overlapping portion of each adjacent pair of parabolas or circular arcs. These calculations are discussed below.

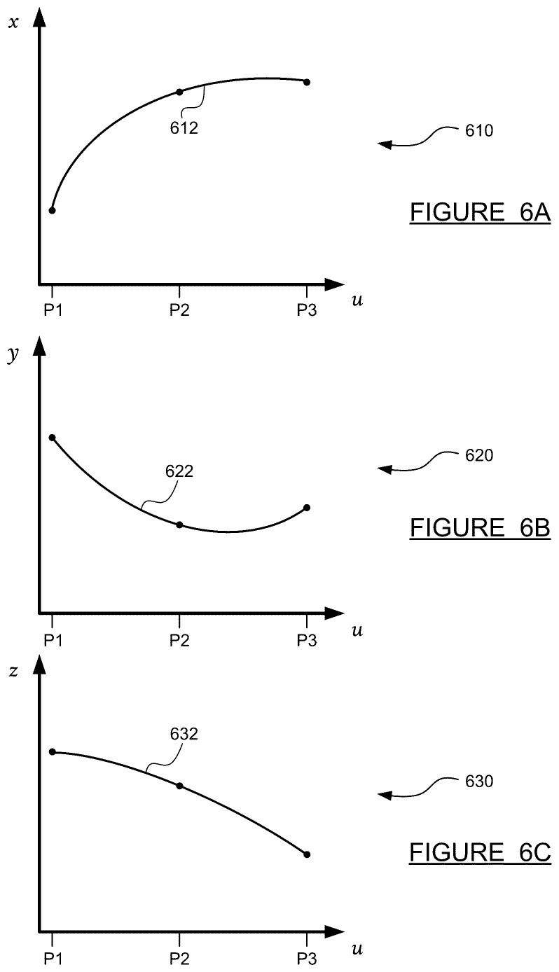

FIGS. 6A, 6B and 6C are graphs of quadratic functions of x, y and z, respectively, with respect to a spline parameter u, illustrating curve fitting calculations through a set of three path points (designated as P1, P2 and P3) according to an embodiment of the present disclosure. The location of each of the path points used in the spline curve calculation is defined in Cartesian coordinates (x, y and z) with respect to a fixed base reference frame. A spline parameter u is defined as an independent variable representing distance along the spline curve. Then, for each set of three adjacent path points, a quadratic function is computed for each of the x, y and z coordinates of the three adjacent path points. FIG. 6A is a graph 610 of a curve 612 depicting a quadratic function of the x coordinate versus u. FIG. 6B is a graph 620 of a curve 622 depicting a quadratic function of the y coordinate versus u. FIG. 6C is a graph 630 of a curve 632 depicting a quadratic function of the z coordinate versus u. FIGS. 6A, 6B and 6C are discussed below in terms of fitting quadratic functions (parabolas) to the points; a discussion of another embodiment where circular arcs are fitted to the points follows.

The curve 612 is computed to fit the x coordinates of the points P1, P2 and P3 as a quadratic function of the independent spline parameter u. Techniques for computing a quadratic function (geometrically defining a parabola) to fit a set of three dependent variable values (the x coordinate values) as a function of an independent variable value (the spline parameter u) are known in the art.

Likewise, the curve 622 is computed to fit the y coordinates of the points P1, P2 and P3 as a quadratic function of the independent spline parameter u, and the curve 632 is computed to fit the z coordinates of the points P1, P2 and P3 as a quadratic function of the independent spline parameter u. The overall three-dimensional path of the quadratic function through P1-P2-P3 is then determined by solving for the x, y and z coordinates, from the curves 612, 622 and 632, respectively, at each incremental position along the spline parameter u. The approach depicted in FIGS. 6A, 6B and 6C and described above is then repeated for each unique set of three sequential path points; i.e., for P2-P3-P4, for P3-P4-P5, etc.

After the parabola or quadratic function through P1-P2-P3 is determined using the curves 612, 622 and 632, and the parabola or quadratic function through P2-P3-P4 is determined similarly, a blend curve must be computed for the overlapping portion between P2 and P3. Let the curve 612, which is the curve representing the x coordinate for a first parabola (passing through P1-P2-P3), be designated as Cₓ₁(u). Similarly, the curve 622 is designated as C_{y1}(u), and the curve 632 is designated as C_{z1}(u). Then, for a second parabola (passing through P2-P3-P4), the three quadratic functions can be computed and designated as Cₓ₂(u), C_{y2}(u), and C_{z2}(u), respectively.

The blend curve between the first parabola and the second parabola (the blend curve 74 of FIG. 5) is computed as follows. The curve Cₓ₁(u) is combined (mathematical combination techniques discussed below) with the curve Cₓ₂(u), for the portion of the curves from the point P2 to the point P3, to define the x coordinate of the blend curve as a function of u. Similarly, the curve C_{y1}(u) is combined with the curve C_{y2}(u), for the portion of the curves from the point P2 to the point P3, to define the y coordinate of the blend curve as a function of u, and the curve C_{z1}(u) is combined with the curve C_{z2}(u), for the portion of the curves from the point P2 to the point P3, to define the z coordinate of the blend curve as a function of u.

The preceding discussion of FIGS. 6A, 6B and 6C described the curves 612, 622 and 632 as being quadratic functions fitting the x, y and z coordinates, respectively, of the points P1, P2 and P3. In an alternate embodiment, a circular arc may be computed instead of a quadratic function or parabola to fit the x, y and z coordinates of the points P1, P2 and P3.

A discussion of the use of circular arcs as the basis function instead of quadratic functions is provided here. A sequence of three points in space defines a plane, and just as a parabola can be fit to the three coplanar points, so can a circular arc be fit to the three points. Techniques for computing a circular arc to fit a set of three dependent variable values (the x, y or z coordinate values of the points P1, P2 and P3) as a function of an independent variable value (the spline parameter u) are known in the art.

Overlapping circular arcs are blended in the same manner as discussed above for the parabolas (i.e., a blending function interpolates between circular arcs, which assures tangency at the endpoints of each segment with its neighbors).

The use of circular arcs instead of parabolas as the basis function may be advantageous in some spline motion control applications. For example, a robot can execute a circular arc with extremely high accuracy, in circumstances when circular motion is needed. If circle points are taught perfectly, the circle will be perfect. If circle points are taught imperfectly (for example, workpiece is not perfectly circular), the imperfection can be tolerated and the path will still be very close to a circle.

On the other hand, the quadratic/parabolic basis function is also more desirable in some circumstances. For example, when circles are not needed, the blended circular arcs have more aggressive curvature than the quadratics, which may require more slowdown than the quadratic basis function. This is particularly true for zig-zag paths. Also, circles are more sensitive to small positional errors in point teaching, especially when two of the points are close together with the third point distant with respect to arc length. Small variations in the taught points may lead to large changes in the resulting circular path. Thus, it may be desirable to use circular arcs as the basis function in some applications, and quadratic functions in other applications.

For the reasons outlined above, the use of quadratic functions (parabolas) or circular arcs as the basis function for the computed spline curves is a user-selectable option. The user defines the set of path points, then creates a motion program with three or more sequential spline motion commands. The spline motion commands can designate either the use of quadratic or circular basis functions. In fact, the user can switch between quadratic and circular basis functions and see the difference in the resulting spline curve, then select the most desirable result.

The overall technique of computing quadratic or circular arc basis functions for each set of three sequential points, and then blending the basis functions in the overlapping region, has been discussed above. According to the techniques of the present disclosure, the curves Cₓ₁(u) and Cₓ₂(u) (and similarly for y and z) may be combined or blended using one of several different function types, including linear, trigonometric (such as cosine) and polynomial (such as quintic). The type of blending function is selectable by the programming operator, and affects the shape of the blending curves, especially affecting how closely the blending curve follows the first parabola (or circular arc) near the first overlap point and how closely the blending curve follows the second parabola (or circular arc) near the second overlap point.

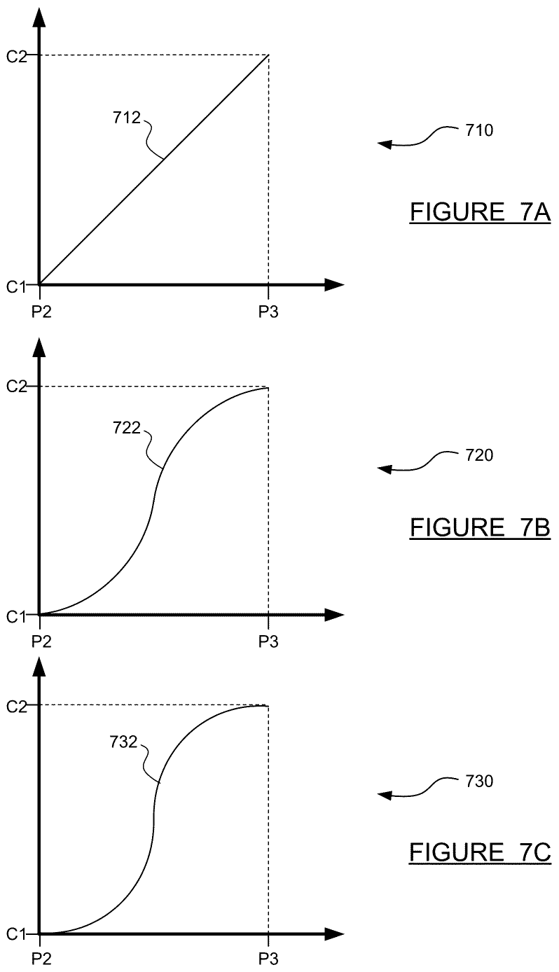

FIGS. 7A, 7B and 7C are graphs of linear, cosine and quintic blending functions, respectively, which may be used for computing a blending curve in overlapping portions of adjacent parabolas (or circular arcs) in a spline curve, according to embodiments of the present disclosure. FIG. 7A is a graph 710 including a curve 712 which defines a linear blending of the curves Cₓ₁(u) and Cₓ₂(u) (and similarly for y and z). Graphically, the curve 712 depicts the weighting factor applied to the first and second parabolas (or circular arcs) as the blending curve moves from the point P2 to the point P3. In the case of linear blending, the curve 712 may be defined as C₇₁₂=(1−w)Cₓ₁(u)+(w)Cₓ₂(u), where w is a parameter corresponding to the spline parameter u from P2 to P3; that is, w=0 at P2 and w=1 at P3. Using linear blending, the curve 712 has a value equal to the curve Cₓ₁(u) at the point P2 and transitions linearly so that the curve 712 has a value equal to the curve Cₓ₂(u) at the point P3. In other words, at 10% of the x coordinate distance from P2 to P3 (w=0.1), the curve 712 has a value which is weighted 90% on Cₓ₁(u) and 10% on Cₓ₂(u), etc.

FIG. 7B is a graph 720 including a curve 722 which defines a cosine-function blending of the curves Cₓ₁(u) and Cₓ₂(u) (and similarly for y and z). In the case of cosine blending, the curve 722 may be defined as

$${C}_{722} = ( \frac{1}{2} ) ( 1 + cos ( π w ) ) {C}_{x 1} ( u ) + ( \frac{1}{2} ) ( 1 - cos ( π w ) ) {C}_{x 2} ( u ) ,$$

where w is defined as before. Using cosine blending, the blending curve 722 again has a value equal to the curve Cₓ₁(u) at the point P2 (w=0) and a value equal to the curve Cₓ₂(u) at the point P3 (w=1), but compared to the linear curve 712, the curve 722 follows the curve Cₓ₁(u) more closely near the point P2 and follows the curve Cₓ₂(u) more closely near the point P3. For example, at 10% of the x coordinate distance from P2 to P3 (w=0.1), the curve 722 has a value which is weighted 97.5% on Cₓ₁(u) and 2.5% on Cₓ₂ (u).

FIG. 7C is a graph 730 including a curve 732 which defines a polynomial-function blending of the curves Cₓ₁(u) and Cₓ₂(u) (and similarly for y and z). One suitable type of polynomial is a quintic function (a fifth degree polynomial). Using quintic blending, the curve 732 may be defined as C₇₃₂=(1−w)³(1+3 w+6 w²)Cₓ₁(u)+(w)³(10−15 w+6 w²)Cₓ₂(u), where w is defined as before. Using quintic polynomial blending, the blending curve 732 again has a value equal to the curve Cₓ₁(u) at the point P2 (w=0) and a value equal to the curve Cₓ₂(u) at the point P3 (w=1), but compared to the cosine curve 722, the curve 732 follows the curve Cₓ₁(u) even more closely near the point P2 and follows the curve Cₓ₂(u) even more closely near the point P3. For example, at 10% of the x coordinate distance from P2 to P3 (w=0.1), the curve 732 has a value which is weighted 99% on Cₓ₁(u) and 1% on Cₓ₂ (u).

Referring again to FIG. 5, the effect of the different types of blending functions shown in FIGS. 7A, 7B and 7C (linear, cosine and quintic) can be interpreted graphically as affecting the shape of the blend curve 74 in transition from the first parabola 70 to the second parabola 72. The type of blending function most suitable for a particular application may be based on a variety of factors—including the characteristics of the geometric shape of the path to be followed by the robot tool center point, the number and spacing of path points, and the type of robotic path following operation (welding, caulking, cutting, etc.). With the different blending function types described above, the programming operator can select the one which provides the most desirable shape of the overall spline curve.

The preceding discussion of FIGS. 4-7 describes in detail how a spline curve may be computed for a sequence of path points, where any number of path points greater than three may be used, the spline curve passes through each of the path points, and the path points may have any point-to-point spacing. Many other advantageous features are also provided by the spline motion control program of the present disclosure, and are discussed below.

Unlike some existing robot motion command types, including existing spline motion programs, the path computed using the techniques of the present disclosure does not vary from the spline curve based on robot joint motions or tool center point speed. That is, the spline curve path is a function only of the path points (along with the type of basis function and the type of blending curve). As a result, the spline curve path can be displayed (on a teach pendant, tablet device or AR device) immediately after the path points have been entered; there is no need to perform robot motion (inverse kinematics) calculations before displaying the spline curve path.

Controlling the speed of the tool center point is important in any robotic path following operation. Using the techniques of the present disclosure, the programming operator has complete flexibility and control over tool center point speed. Real tool center point speeds, in Cartesian coordinates, are maintained throughout spline curves created with the S motion type, with no slowdown at path points if “termtype” is “CNT100” (which means continue at 100%). For example, if each of the S motion commands in a sequence calls for a speed of 75 mm/sec, and each command has “termtype” of “CNT100”, the tool center point will follow the resultant spline curve at a constant speed of 75 mm/sec. Lower “CNT” values allow slowdown at path points if desired by the operator. For example, the operator may want the robot tool to slow down to half speed near a certain path point, in which case the operator would specify that path point with “CNT50”. As mentioned above, the spline curve passes directly through the path points regardless of speed.

Automatic speed limiting is a feature of most robot motion control programs. Automatic speed limiting may be applied to the spline motions of the present disclosure based on threshold limits of tool center point acceleration or jerk. For example, using the example of a spline motion with a constant speed of 75 mm/sec discussed above, if that tool center point velocity causes too high of a lateral acceleration when the spline follows a very tight curve, then the tool center point velocity will be automatically reduced in that portion of the spline curve to prevent the lateral acceleration from exceeding a predefined threshold. The threshold may have a value such as 1G or 2G's, or higher or lower, depending on several factors—such as the size and stiffness of the robot, and the mass of the tool or other object being carried by the robot.

Automatic speed limiting may also be applied to the spline motions of the present disclosure based on threshold limits of joint rotational velocity or acceleration. In this case, each robot rotational joint has a maximum allowable rotational velocity and acceleration. When robot joint motions to follow the spline curve are computed through inverse kinematics, if any of the joints exceed their rotational velocity or acceleration threshold, joint threshold limits will be applied and as a result the velocity of the tool center point will be lower than the value prescribed by the programming operator.

The disclosed spline motion control program can anticipate any type of tool center point slowdown—whether due to a reduced “CNT” value in the program, or whether due to an automatic speed reduction related to tool center point Cartesian limits or joint rotational limits. Any such tool center point slowdown can be communicated to process equipment so that the process equipment can compensate (such as by reducing the flow of caulk in proportion to the slowdown, for example).

Tool orientation control is another important feature in robot motion programming. Tool orientation control may be applied to the spline motions of the present disclosure using at least two different techniques. One technique is to define a tool orientation by manually configuring the robot and tool with a teach pendant when defining the path points, and then blending the orientation across segments. Another technique is based on three-angle orientation control with respect to a fixed “base” reference frame. An example is discussed below which illustrates how the desired orientation control is achieved using three-angle orientation control techniques of the present disclosure in connection with a spline curve path of the type discussed above.

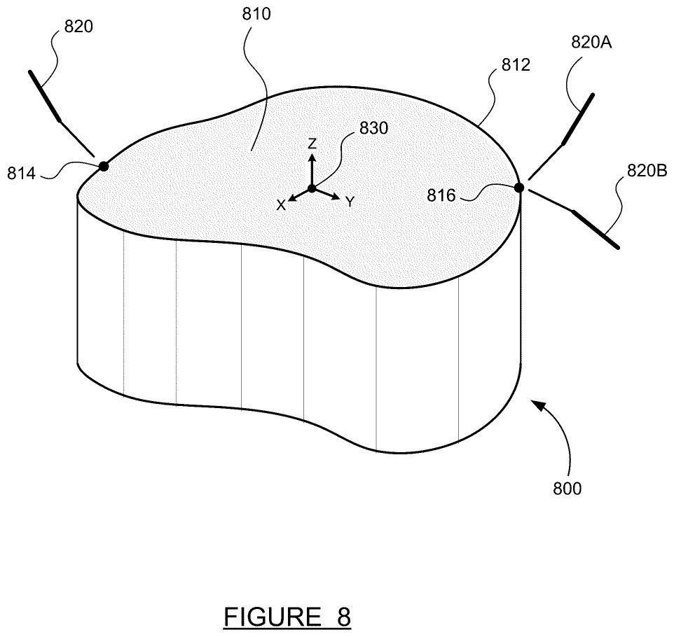

FIG. 8 is an illustration of a robot tool during spline motion, with and without orientation control with respect to a fixed reference frame, according to an embodiment of the present disclosure. A workpiece 800 has an upper surface 810 (shaded), and the upper surface 810 has an outer periphery 812. The outer periphery 812 may be described by a spline curve as discussed above according to the present disclosure, where a robot is programmed to cause a tool 820 to follow the spline curve along the outer periphery 812. For example, the robot may be fitted with a dispensing system, where the tool 820 is a dispensing tip designed to apply a bead of adhesive material. A fixed reference frame 830 is defined, where the fixed reference frame 830 may have its origin on a robot base, or elsewhere in the work cell in which the robot operates on the workpiece. In this case, the X-Y plane of the fixed reference frame 830 is coplanar or parallel with the plane of the upper surface 810.

In the application of FIG. 8, consider that there is a requirement that the tool 820 always remains perpendicular to a local tangent of the spline curve defining the outer periphery 812. In addition to remaining perpendicular to the local tangent of the spline curve, the tool 820 is to have a 45° downward angle (angle of intersection with the plane of the surface 810), where the 45° downward angle provides optimal application of the bead of adhesive material. This means that the tool 820 should always intersect the X-Y plane of the fixed reference frame 830 at a 45° angle, and a projection of the tool 820 should always make a 45° angle with the Z-axis (vertical axis) of the fixed reference frame 830. The tool 820 is shown in the proper position and orientation at a path point 814 at the left of the workpiece 800.

Using the spline computation techniques discussed above and orientation control features of the present disclosure, tool orientation may be maintained according to the requirements discussed above. Specifically, a three-angle orientation control with respect to a fixed reference frame is provided. The reference frame 830 may be used as the fixed reference frame for orientation control. Tool orientation azimuth, elevation and spin angles are then computed along with robot joint kinematics. Robot joint motions can be computed such that a tool elevation angle of 45° above the X-Y plane of the frame 830 is maintained throughout the spline curve along the periphery 812; this is shown as tool 820A at a path point 816 at the right of the workpiece 800.

Without the elevation angle control feature of the present disclosure, the tool 820 could be positioned such that it is perpendicular to the spline curve at the path point 816, but at entirely the wrong elevation angle. This is shown as tool 820B at the path point 816. Not only would the tool 820B provide an unsatisfactory bead of the adhesive material due to the improper tool orientation, but the tool 820B or some part of the robot may actually interfere with a fixture or other object due to the low tool elevation angle. This example illustrates the importance of being able to define elevation angle orientation control with respect to a fixed reference frame.

In addition, many tools have a “dogleg” bend or other axial asymmetry which makes the spin angle of the tool important. The spin angle is the angular rotational position about a local Z axis along a length of the tool. Using the orientation control techniques of the present disclosure, the spin angle of the tool 820 is also properly controlled. The desired spin angle of the tool 820 is defined and shown at the path point 814, and is maintained all the way around the workpiece 800 to the path point 816, where the tool 820A has proper orientation in both elevation and spin angles. In contrast, the tool 820B, computed without three-angle orientation control with respect to the fixed reference frame 830, has not only the wrong elevation angle as discussed above, but also the wrong spin angle. This further illustrates the importance of three-angle orientation control with respect to a fixed reference frame when computing robot motions for spline curves.

Many other applications exist where the orientation control techniques discussed above are important. The spline curve path being followed need not be planar; it could have any three-dimensional shape. The azimuth and elevation angle requirements may be different than those discussed above. In any such application, the disclosed three-angle orientation control with respect to a fixed reference frame provides the capability to meet the requirements.

In applications where a circular arc basis function is used, circular orientation control can be used similar to regular (non-spline) circular motion, similar to the azimuth, elevation and spin angle control discussed above, except that the three angles are computed with respect to a local circle reference frame rather than a separately-defined reference frame.

Most robotic path following applications involve some type of process equipment being moved and controlled by the robot. Examples of types of process equipment include welders (laser, arc or torch), cutters, material dispensers and spray painters. In these applications, the robot is not only responsible for moving the tool tip along the prescribed path at the desired speed and orientation, the robot controller also provides control signals to the process equipment. In the case of a material dispensing system, the control signals would include at least: Process ON (begin dispensing); Process OFF (stop dispensing); and Set Flowrate (of dispensed material). Trigger points, defined in the spline motion commands of the type shown in FIGS. 4 and 5, are known in the art as a means of defining the control signals relative to a defined path. However, existing robot spline motion control systems do not offer the flexibility and precision needed for most effective definition of trigger points.

Trigger points need not be coincident with path points. Whereas path points define the shape of the path (e.g., spline curve), trigger points cause process control commands to be executed. With the spline motion control techniques of the present disclosure, trigger points may be established with respect to a spline curve and its path points in at least four ways, including: time before a path point; time after a path point; distance before a path point; or distance after a path point. For example, a Process ON trigger point may be defined at a time of 1.2 seconds before a particular path point is reached, and a Process OFF trigger point may be defined at a time of 0.6 seconds after a different path point is reached. In the case of “time before” and “time after” trigger points, the robot controller knows exactly where on the spline curve these trigger points are located, because the controller knows the tool center point speed at all points along the spline curve and the exact distance along the spline curve (represented by the spline parameter u discussed earlier). Similarly, a Process ON trigger point may be defined, for example, at a distance of 75 mm before a particular path point is reached. Again, in the case of “distance before” and “distance after” trigger points, the robot controller knows exactly where to locate the trigger point, and the “distance before” or “distance after” is the true distance along the spline path from the trigger point to the path point, not the straight line distance from the trigger point to the path point.

In addition to the individually activated trigger points described above, periodic trigger points may be defined. With periodic triggering, a time-based or distance-based sequence of on and off commands is issued to the process equipment. Periodic triggering may be employed in “stitch” sealing for example, where a sort of dashed line of sealant is applied to a workpiece. The usage of periodic triggering in other types of process equipment applications (e.g., laser welding) may be readily envisioned. With time-based periodicity, a first trigger point may be used to initiate the sequence, and then a periodic sequence of commands may be automatically issued, such as “on for 1.6 seconds” and “off for 1.1 seconds”, until a second trigger point ends the periodic sequence. With distance-based periodicity, a first trigger point may again be used to initiate the sequence, and then a periodic sequence of commands may be automatically issued, such as “on for 55 mm” and “off for 40 mm”, until a second trigger point ends the periodic sequence. With distance-based periodicity, the distance may be defined as a Cartesian distance (true 3D distance, or any of X, Y or Z coordinate distances), or the distance may be defined as the distance traveled along the tool center point path (e.g., along the spline curve).

By using true distance along the spline curve and true time to travel along the spline curve, the trigger points discussed above provide the precision needed to achieve the desired results in process operations such as material dispensing, spray painting, welding and cutting.

It is well known in the art to use a teach pendant or equivalent device to manually “step” through a robot motion program during an evaluation/optimization phase before the program is confirmed for production usage. However, when spline curves are involved, existing systems do not always provide the desired true spline motion during single step motion control. These deficiencies of prior art systems are overcome with the spline motion control techniques of the present disclosure.

Using the presently disclosed spline motion control, if program is put on hold while in the middle of a spline motion segment, a step forward command will cause the robot tool to move to the next path point along the spline curve path, as desired. Because of the complexity of the spline curves, some existing systems cannot follow the spline path after a hold and resume motion. Similarly, the presently disclosed spline motion control follows the spline curve to a previous path point when a hold is followed by a step backward command. Furthermore, if the operator pauses or holds the motion program, then jogs the tool away from the spline curve path, then resumes the program, the tool will first move directly back to the spline curve path, then continue along the spline path to the next path point.

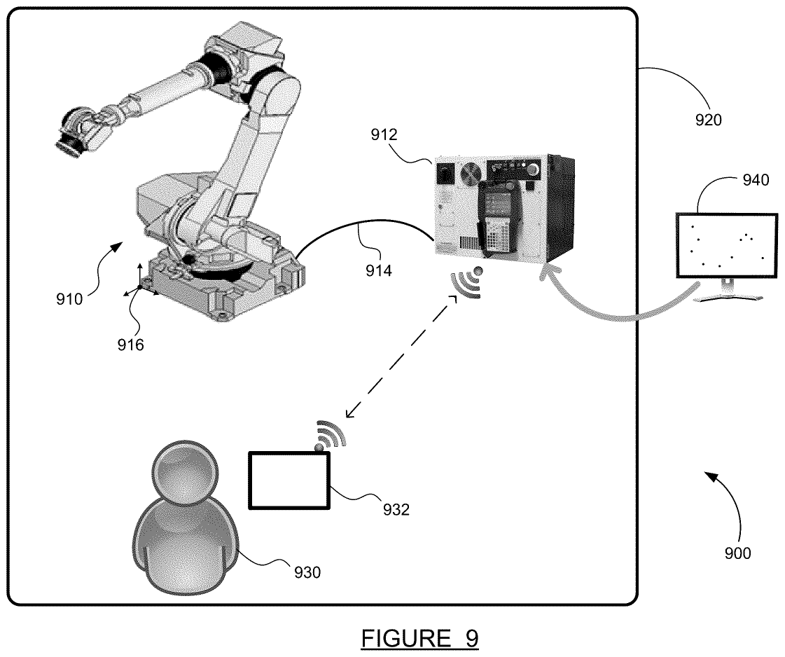

FIG. 9 is an illustration of a system 900 for robotic spline motion control, according to an embodiment of the present disclosure. A robot 910 is located in and operates in a work cell 920. The robot 910 is depicted as a traditional multi-axis articulated industrial robot with arms connected in series at rotational joints, but may be any other type of robot—including, but not limited to, industrial robots configured for part/material movement, welding, painting or other applications, etc. In fact, while a robot is used for illustration in FIG. 9, the disclosed technique for spline motion could be used with any type of articulated machine which is required to follow a path having any arbitrary geometry.

The robot 910 communicates with a controller 912, typically via a cable 914. As is known in the art, the controller 912 includes a processor and memory with instructions for operating the robot 910 according to a program, where the controller 912 receives position information from joint encoders on the robot 910 and sends commands to the robot 910 defining joint motor motion. Only one robot 910 is shown in FIG. 9, but the system 900 may include two or more of the robots 910 operating within the work cell 920. When more than one of the robots 910 is included in the system 900, each of the robots 910 may have its own controller 912, and the controllers 912 communicate with each other.

The robot 910 has a robot base reference frame 916, which is a fixed reference frame with its origin on the robot base or somewhere within the work cell 920, where the positions of all robot arms are always known relative to the robot base reference frame 916 through kinematics calculations. That is, the kinematics of the robot, particularly the length of each arm from one joint center to the next, is known exactly. Joint angular position is also known at all times from joint position encoders. Beginning with a base joint, which may have its rotational axis aligned with an axis of the robot base reference frame 916, the position of each arm and the location of the joint center at the end of each arm can be computed in the coordinates of the robot base reference frame 916. Inverse kinematics calculations are used to determine joint motions required to cause the tool center point to follow a prescribed path, such as a spline curve path according to the present disclosure. The robot base reference frame 916 may also be used as the fixed work cell coordinate frame with respect to which all path points are defined and the spline curve is computed. Other local coordinate frames may also be defined, such as one coordinate frame fixed to each arm, as would be understood by those skilled in the art.

An operator 930 may be present in the work cell 920 during teaching operations of the robot 910. The operator 930 uses a teach device 932 to teach path points on a real workpiece (not shown) which is placed in the work cell 920. The teach device 932 may be an AR headset apparatus worn by the operator 930 or a handheld device (e.g., a smart phone, a tablet or a teach pendant) held by the operator 930. When the teach device 932 is a headset, the headset includes a processor, inertial sensors, a camera and goggles which overlay computer-generated 3D images on top of the user's view or camera images of real-world objects. The teach device 932 may also be a handheld device, in which case the device 932 still includes a processor, inertial sensors, a camera and a display screen, in addition to the required communications system. The teach device 932 may not be required if the path points are defined in another manner, such as from a CAD system.

The teach device 932 is in two-way wireless communication with the controller 912 so that taught path points may be communicated from the teach device 932 to the controller 912, and the spline curve computed by the controller 912 may be communicated to the teach device 932 for display. Other types of data may also be communicated between the teach device 932 and the controller 912, as would be understood by one skilled in the art. Communication between the teach device 932 and the controller 912 may be hard-wired or wireless. Wireless communication between the teach device 932 and the controller 912 may be via a wireless local area network (WiFi), Bluetooth, cellular communication or any other suitable wireless technology. If the work cell 920 includes a plurality of the robots 910, then the teach device 932 preferably communicates with only one of the controllers 912 (designated as a master).

A computer 940 may provide CAD data to the controller 912. In this case, the CAD data includes a plurality of path points to be used in the spline curve computation, such as the set of path points 10 of FIG. 1. The computer 940 may be any type of computer, server or storage device capable of providing the CAD data to the controller 912. Although a hard-wire (network) connection between the computer 940 and the controller 912 is shown, a wireless connection (WiFi, etc.) may also be used.

In the system 900, the controller 912 is configured to receive the path points, compute the spline curve(s) as discussed above, and use the computed spline curve(s) for motion control of the robot 910. Spline motion control of the robot 910 includes causing the tool center point to follow the computed spline curve(s) with the prescribed orientation and speed, providing triggering commands such as ON/OFF commands to process equipment, etc. The teach device 932 may also be used to control the robot 910 via the controller 912, such as by issuing manual motion commands (step forward, step backward, etc.) from the operator 930.

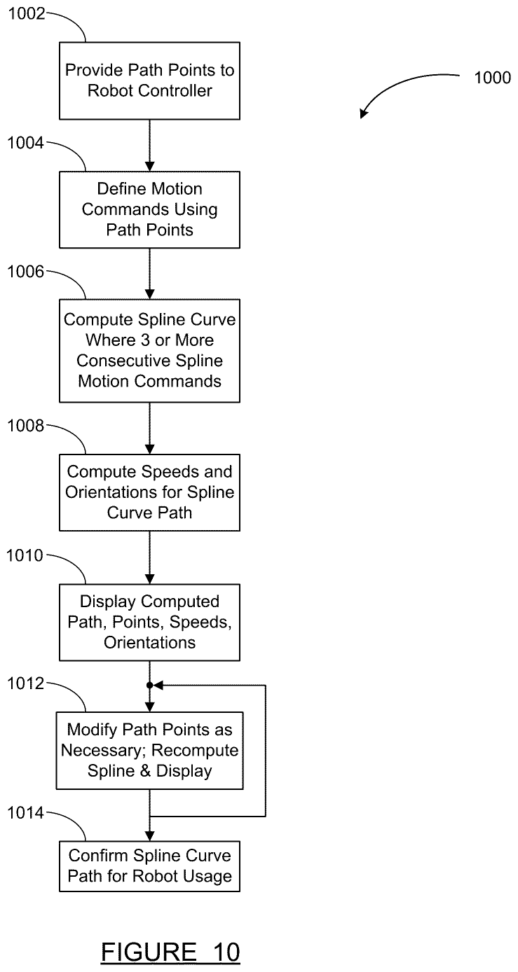

FIG. 10 is a flowchart diagram 1000 of a method for spline motion control for a robot or other industrial machine, according to an embodiment of the present disclosure. At box 1002, a plurality of path points are defined and provided to the robot controller 912. The path points may be defined one at a time using a handheld device such as a teach pendant, or the path points may be provided from a CAD system. At box 1004, motion commands are defined referring to the path points. The motion commands may be entered on the teach pendant and communicated to the controller 912, or defined in some other manner as known in the art. The motion commands include a motion type (Joint, Line or Spline, for example), a destination path point ID, a speed and a termination type, along with optional trigger point parameters. The motion commands may also include selection of basis function type (quadratic or circular arc) and blending curve type (linear, cosine or quintic).

At box 1006, the controller 912 computes the path based on the motion commands, including computing spline curve path segments where 3 or more S commands appear sequentially. Spline curve path segments are computed as described in detail above, including computing a quadratic function (parabola) or circular arc for each unique set of three adjacent path points, and computing blending curves to span the overlapping portion of each pair of adjacent parabolas or arcs. At box 1008, tool center point speeds and tool orientations are computed for the spline curve path. In order to compute the tool center point speeds and tool orientations, the joint motions to follow the spline curve path must also be computed using inverse kinematics. As discussed above, tool center point speeds are maintained at the values defined in the motion commands, regardless of the density of path points or other factors, except where automatic speed limiting is required to prevent excessive tool center point acceleration or jerk or excessive joint velocity or acceleration. Tool orientations may be computed to suit the operator's preference, including using three-angle orientation control with respect to a fixed reference frame as discussed above.

At box 1010, the path points, along with the computed path, speeds and orientations are displayed for viewing by the operator. The graphics may be displayed on a teach pendant, tablet device, AR device, etc. When an AR device is used, the computed path may be superimposed on a real workpiece in an AR display, enabling the operator to visually verify how closely the computed spline curve follows the contour of the real workpiece. In an alternate embodiment, the spline curve and path points are displayed immediately after the spline curve is computed at the box 1006, rather than after the joint motions are computed at the box 1008.

At box 1012, the operator optionally modifies or inserts path points or commands as necessary to achieve a suitable path. For example, when viewing the display of the computed spline path at the box 1010, the operator may determine that one or more additional path points should be inserted between existing path points in order to adjust the shape of the spline curve. As discussed earlier, the operator need not worry about artificial point spacing restrictions, as there are no such restrictions in the present spline curve computation technique. The operator is also assured that the resulting spline curve path will pass through all path points, including path points newly added or inserted after a first spline curve is computed and displayed. The operator may also change the type of basis function or the type of blending curve used in the spline curve computations. After curve type and/or path point modifications are made at the box 1012, the spline curve is recomputed, along with speeds and orientations, and the updated information is displayed for operator review. Path point and/or curve type modifications are repeated if necessary until the operator is satisfied with the resulting spline curve.

At box 1014, the final motion program is approved or committed for actual production usage by the robot/controller. The confirmed motion program includes the final set of path points, the computed spline curve path (and other path type segments if used), tool center point speeds, tool orientations, and trigger points and commands.

Throughout the preceding discussion, various computers and controllers are described and implied. It is to be understood that the software applications and modules of these computer and controllers are executed on one or more computing devices having a processor and a memory module. In particular, this includes processors in the computer 940, the robot controller 912 and the teach device 932 discussed above. Specifically, the processor in the controller 912 is configured to compute the spline curve(s) based on the path points in the manner discussed above. Communication between these devices, and between these devices and any other devices (such as a server or a factory master controller) may be over a hard-wire network, or may use any suitable wireless technology—such as a cellular phone/data network, Wi-Fi, broadband Internet, Bluetooth, etc.

As outlined above, the disclosed techniques for spline motion control of a robotic continuous path offer several advantages over prior art techniques. These advantages include the computed spline curve passing through every path point, no restrictions on placement or spacing of path points, user control of the characteristics of the basis function and the blend curves used in the spline curve, tool center point speeds maintained at user-defined values regardless of number of path points, automatic speed controls to prevent excess tool center point acceleration or joint velocity, improved tool orientation control, and flexible definition of trigger points with respect to path points.

While a number of exemplary aspects and embodiments of the method and system for spline motion control of a robotic continuous path have been discussed above, those of skill in the art will recognize modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for providing spline motion control of an industrial robot, said method comprising:
defining a plurality of path points through which a tool center point of the robot is to pass;
computing a spline curve path which passes through the path points in a prescribed order, including computing a basis function which passes through each unique set of three adjacent path points, and computing a blending curve to span an overlapping portion of each pair of adjacent basis functions;
computing robot joint motions which cause the tool center point to follow the spline curve path while meeting a defined tool center point speed profile and a defined tool orientation requirement; and
controlling the robot using the computed robot joint motions, including providing control signals to process equipment while controlling the robot, where the control signals are activated based on trigger points which have a defined spatial or temporal relationship to one or more of the path points.

2. The method according to claim 1 wherein the basis function is a quadratic function or a circular arc.

3. The method according to claim 1 wherein the spline curve path is comprised of a first portion of a first basis function, each of the blending curves, and a last portion of a last basis function.

4. The method according to claim 1 wherein the basis function for each unique set of three adjacent path points includes a basis function for each of an x, y and z Cartesian coordinate of the path points as a function of an independent spline length parameter.

5. The method according to claim 4 wherein the blending curves are computed for each of the basis functions of the x, y and z Cartesian coordinates of the path points, and the blending curves include a linear function, a cosine function and a quintic function.

6. The method according to claim 1 wherein the plurality of path points are defined using computer aided design (CAD) data, or are defined using a teach device operated in proximity to a physical workpiece.

7. The method according to claim 1 wherein the tool center point speed profile is defined based on a user-defined tool center point speed for each of the path points, and the speed profile is automatically modified when necessary to prevent the tool center point from exceeding a predefined maximum acceleration or jerk, or to prevent the robot joint motions from exceeding a predefined maximum rotational velocity or acceleration.

8. The method according to claim 1 wherein the tool orientation requirement is defined by blending tool orientations which are manually taught at the path points, or is defined using three-angle orientation control with respect to a fixed reference frame, where the three-angle orientation control includes control of azimuth and elevation angles with respect to the fixed reference frame, and control of a spin angle around an axis of a local tool reference frame.

9. The method according to claim 1 wherein the trigger points are defined as occurring at a prescribed time before one of the path points, a prescribed time after one of the path points, a prescribed distance before one of the path points, or a prescribed distance after one of the path points.

10. The method according to claim 1 wherein the trigger points are defined as occurring periodically, beginning at a start trigger point defined in relationship to a path point, continuing with a time-based or distance-based sequence of process equipment on and off commands, and ending at a stop trigger point.

11. The method according to claim 1 further comprising displaying the spline curve path and the path points on a display device before computing the robot joint motions, including displaying the spline curve path and the path points, on an augmented reality (AR) device, superimposed on camera images of a physical workpiece.

12. The method according to claim 11 further comprising defining one or more additional path points or modifying one or more existing path points by an operator after viewing the spline curve path on the display device, and recomputing the spline curve path.

13. The method according to claim 1 wherein computing the spline curve path, computing the robot joint motions and controlling the robot are performed by a robot controller in communication with the robot.

14. A method for providing spline motion control of an industrial robot, said method comprising:
providing, to a robot controller, a plurality of path points through which a tool center point of the robot is to pass, and a sequence of spline motion commands designating the path points in a prescribed order;
computing, by the controller, a spline curve path which passes through the path points in the prescribed order, including computing a basis function which passes through each unique set of three adjacent path points, and computing a blending curve to span an overlapping portion of each pair of adjacent basis functions, where the spline curve path is comprised of a first portion of a first basis function, each of the blending curves, and a last portion of a last basis function, and where the basis function is a quadratic function or a circular arc;
displaying the spline curve path and the path points on a display device, and modifying the path points as desired by an operator;
computing, by the controller, robot joint motions which cause the tool center point to follow the spline curve path while meeting a defined tool center point speed profile and a defined tool orientation requirement; and
controlling the robot, by the controller, using the computed robot joint motions, including providing control signals to process equipment while controlling the robot, where the control signals are activated based on trigger points which have a defined spatial or temporal relationship to one or more of the path points.

15. The method according to claim 14 wherein the basis function for each unique set of three adjacent path points includes a basis function for each of an x, y and z Cartesian coordinate of the path points as a function of an independent spline length parameter, and wherein the blending curves are computed for each of the basis functions of the x, y and z Cartesian coordinates of the path points, and the blending curves include a linear function, a cosine function and a quintic function.

16. An industrial machine system with spline motion control, said system comprising:
an industrial machine;
a machine controller having a processor and memory and in communication with the machine, said controller being configured to perform steps including;
receiving a plurality of path points through which a tool center point of the machine is to pass;
computing a spline curve path which passes through the path points in a prescribed order, including computing a basis function which passes through each unique set of three adjacent path points, and computing a blending curve to span an overlapping portion of each pair of adjacent basis functions;
computing machine joint motions which cause the tool center point to follow the spline curve path while meeting a defined tool center point speed profile and a defined tool orientation requirement; and
controlling the machine using the computed machine joint motions, including providing control signals to process equipment while controlling the machine, where the control signals are activated based on trigger points which have a defined spatial or temporal relationship to one or more of the path points.

17. The system according to claim 16 wherein the basis function for each unique set of three adjacent path points includes a quadratic function or a circular arc for each of an x, y and z Cartesian coordinate of the path points as a function of an independent spline length parameter.

18. The system according to claim 17 wherein the blending curves are computed for each of the basis functions of the x, y and z Cartesian coordinates of the path points, and the blending curves include a linear function, a cosine function and a quintic function.

19. The system according to claim 16 wherein the tool center point speed profile is defined based on a user-defined tool center point speed for each of the path points, and the speed profile is automatically modified when necessary to prevent the tool center point from exceeding a predefined maximum acceleration or jerk, or to prevent the machine joint motions from exceeding a predefined maximum velocity or acceleration.

20. The system according to claim 16 wherein the tool orientation requirement is defined by blending tool orientations which are manually taught at the path points, or is defined using three-angle orientation control with respect to a fixed reference frame, where the three-angle orientation control includes control of azimuth and elevation angles with respect to the fixed reference frame, and control of a spin angle around an axis of a local tool reference frame.

21. The system according to claim 16 further comprising a display device on which the spline curve path and the path points are displayed before the machine joint motions are computed, including displaying the spline curve path and the path points superimposed on camera images of a physical workpiece when the display device includes augmented reality (AR) functionality.

22. The system according to claim 16 wherein the trigger points are defined individually as occurring at a prescribed time before one of the path points, a prescribed time after one of the path points, a prescribed distance before one of the path points, or a prescribed distance after one of the path points, or wherein the trigger points are defined as occurring periodically, beginning at a start trigger point defined in relationship to a path point, continuing with a time-based or distance-based sequence of process equipment on and off commands, and ending at a stop trigger point.

23. The system according to claim 16 wherein the process equipment is moved by the industrial machine, and the process equipment includes a device selected from a group including welders, cutters, material dispensers and spray painters.
